(19) United States
(12) Patent Application Publication
(10) Pub. No.: US 2022/0394962 A1
(43) Pub. Date: Dec. 15, 2022

(54) FISHING LURE WITH CORKSCREW ACTION

(71) Applicant: Zach MEDINAS, Concord, CA (US)

(72) Inventor: Zach MEDINAS, Concord, CA (US)

(21) Appl. No.: 17/839,230

(22) Filed: Jun. 13, 2022

Related U.S. Application Data
(60) Provisional application No. 63/209,945, filed on Jun. 11, 2021.

(51) Int. Cl. A01K 85/12

(52) U.S. Cl. CPC A01K 85/12

(57) ABSTRACT

An example fishing lure includes a body shaped as a baitfish that has a head and a tail, wherein the body includes: a head portion that mimics the head of the baitfish and a tail portion that mimics the tail of the baitfish, wherein the head portion is bent in a first direction and the tail portion is bent in a second, different direction so that the body is curved like a corkscrew arc, wherein the head portion includes a tip, whereby when towed through water by its tip, the lure corkscrews through water.

### CROSS-REFERENCE TO RELATED APPLICATION(S)

This application claims priority to provisional U.S. Application No. 63/209,945, filed Jun. 11, 2021, and is a continuation-in-part of U.S. Design application Ser. No. 29/805,923, filed Aug. 31, 2021, the contents of each of which are incorporated herein by reference in their entireties.

### BACKGROUND

### 1. Field

The disclosure relates to a fishing lure with corkscrew action.

### 2. Description of Related Art

Fishing lures come in many forms and sizes and are deployed in many ways. Some are used when trolling from a fishing vessel—a boat, a paddle kayak, or an ocean jet ski—and others are used when casting and retrieving with a rod and reel, something fishermen on Maui, Hawaii call “whipping.”

Trolling with lures can often be effective, which is usually when the fishing comes with a lot of catching. One can troll with lures and catch marlin, bluefin tuna, bill fish, wahoo, and dorado, typically in warmer waters. In colder waters, like those off the coast of Northern California, one can catch salmon and occasionally halibut and rockfish, the latter two of which seem to prefer the cover and safety provided by the sea floor.

Fishing vessels used for trolling often have speed constraints, especially under inclement weather conditions. For example, the outboard motors popular on recreational fishing boats have a troll mode, primarily to save gas and mitigate wear and tear. But in troll mode, speed is typically limited to something less than five to seven knots. And depending on the magnitude of swells, wind waves, wind speed and their direction relative to boat heading, it may not be possible, while in troll mode, to troll one's lure so it swims properly, which is key if one wants to catch and not just fish.

Some predator fish, for example, king salmon, are notoriously finicky when it comes to lures. They have been filmed following a lure and strike only if the lure passes careful scrutiny. King salmon and similar species have excellent vision and a well-developed sense of smell. They usually will not strike lures that do not swim properly or lures that have unwelcome scents, for example, those of jellyfish.

### SUMMARY

A fishing lure of the subject patent application, when towed through the water, is colored, scented, coated with a reflective coating, shaped, and curved to realistically mimic a baitfish swimming, e.g., an injured baitfish swimming. The curvature of the lure, given its particular shape, produces a corkscrew action when the lure is being pulled through water submerged, i.e., it causes the lure to corkscrew through water, rather than just dodge side to side or simply spin. This corkscrew action has been empirically determined to produce more strikes than dodging side to side or simply spinning. The lure is thus designed and configured to pass close scrutiny and entice a strike, even by finicky predator fish.

A lure in accordance with aspects of the subject patent application can provide any combination of the following advantages. Because it mimics the action, looks, reflectance, and/or scent of baitfish and, furthermore, can be customized for a particular region, a particular target species of fish, and particular time of year, the lure will on average induce more strikes over time. Because of its ability to keep its hook relatively steady, the lure on average hooks fish more securely. When organic baitfish is not available at an appropriate size or at all, the lure can be a suitable substitute and enable one to fish with reasonable prospects of catching. Under circumstances when the appropriate speed at which the lure if being pulled through water cannot be achieved safely, conveniently, or at all—for example, when it is difficult for the boat to troll at the proper speed—one can simple select the proper one of the set of lures so that it swims with the proper corkscrew action at whichever trolling speed is sustainable.

### BRIEF DESCRIPTION OF THE DRAWINGS

The above and other aspects, features, and advantages of certain embodiments (i.e. examples) of the disclosure will be more apparent from the following description taken in conjunction with the accompanying drawings, in which:

FIGS. 1, 2, 3, 4, and 5 are views of a fishing lure in accordance with various embodiments.

FIG. 6 schematically illustrates a corkscrew motion of an example lure according to an embodiment.

FIGS. 7A-7G are a front perspective view, a front view, a rear view, a top view, a bottom view, a right side view, and a left side view of an example embodiment of a fishing lure.

FIGS. 8A-8G are a front perspective view, a front view, a rear view, a top view, a bottom view, a right side view, and a left side view of another example embodiment of a fishing lure.

FIG. 9 is an example embodiment in which a lure includes a chamber or cavity formed therein.

### DETAILED DESCRIPTION OF EXAMPLE EMBODIMENTS

Hereinafter, various embodiments (i.e. examples) of the disclosure may be described with reference to the accompanying drawings. Accordingly, those of ordinary skill in the art will recognize that modifications, equivalents, and/or alternatives on the various embodiments described herein can be variously made without departing from the scope and spirit of the disclosure. With regard to description of drawings, similar components may be marked by similar reference numerals.

In the disclosure, the expressions “have”, “may have”, “include” and “comprise”, or “may include” and “may comprise” indicate existence of corresponding features (e.g., components such as numeric values, functions, operations, or parts), but do not exclude presence of additional features.

In the disclosure, the expressions “A or B”, “at least one of A and/or B”, or “one or more of A and/or B”, and the like may include any and all combinations of one or more of the associated listed items. For example, the term “A or B”, “at least one of A and B”, or “at least one of A or B” may refer to all of a case (1) in which at least one A is included, a case (2) in which at least one B is included, or a case (3) in which both of at least one A and at least one B are included.

Terms such as “first”, “second”, and the like used in the disclosure may be used to refer to various components regardless of the order and/or the priority and to distinguish the relevant components from other components, but do not limit the components. For example, “a first user device” and “a second user device” can indicate different user devices regardless of the order or priority. For example, without departing the scope of the disclosure, a first component may be referred to as a second component, and similarly, a second component may be referred to as a first component.

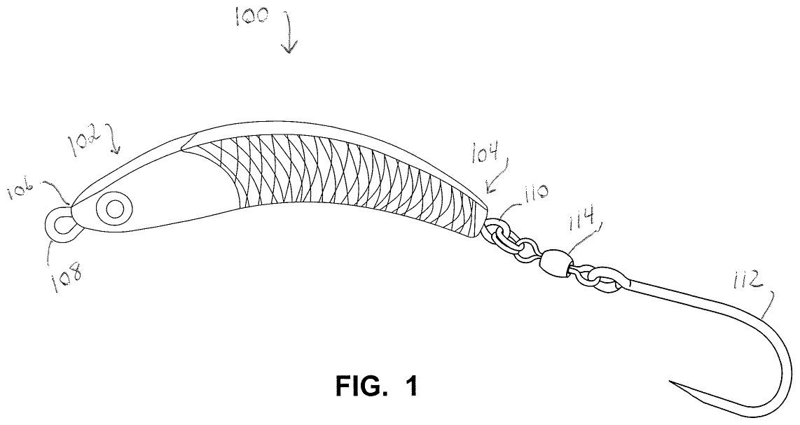

As shown in FIG. 1, an example fishing lure 100 is shaped to mimic the size and shape of a particular baitfish that is prey to a species of fish being targeted by a fisherman. Importantly, the manner in which the lure swims when pulled through water, i.e., its action, is determined by its shape and, moreover, how it is curved. The lure 100 has a head portion 102 and a tail portion 104. The head portion 102 has a tip 106 including a closed loop 108 to which a fishing line may be secured (e.g., directly or using a snap swivel). The tail portion includes a closed loop 110 to which a hook 112 is secured via a snap swivel 114. While loops 108 and 110 are shown as closed loops, one or both of these loops may be open loops. In addition, loops 108 and 110 may be formed integrally with the lure or may be formed separately and secured to the lure, e.g., via screw threads or some other fastening mechanism. Moreover, while a single hook 112 is illustrated, multiple single hooks may be attached to the lure or hook 112 may be implemented as a double hook or a triple hook. One or more double hooks or triple hooks may be attached to lure 100.

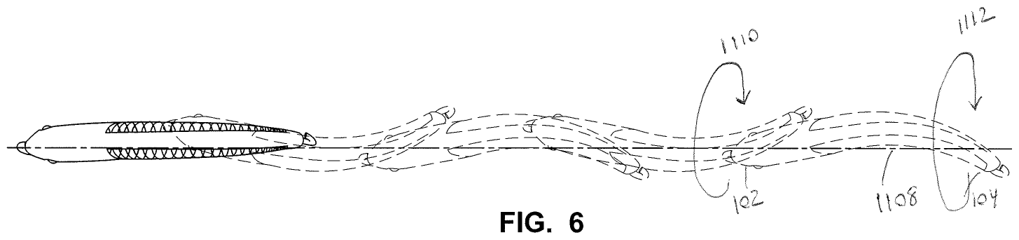

In the implementation depicted in FIG. 1, the lure 100 is shaped to mimic the size and shape of an anchovy, although the disclosure is not limited in this respect. For example, the lure 100 may be between about 4 and 6 inches in length, but the embodiments disclosed herein are not limited in this respect. As will be appreciated, the size of the lure may be upsized for larger fish and downsized for smaller fish. The body of the lure 100 is curved similar to the way a portion of a corkscrew is curved so that when pulled through water, it “swims” and penetrates the water similar to the way a corkscrew penetrates a cork (see FIG. 6), generally spiraling around a figurative longitudinal axis 108. As indicated by arrows 1110 and 1112, the head portion 102 and the tail portion 104, respectively, each spirals around the axis 1108 when the lure is pulled through water.

When viewed from the side of the lure 100 as it “swims” as if it is being pulled from the reader's left to right, which in effect projects the head portion's 102 three-dimensional spiral movement onto a two-dimensional plane, this movement appears to oscillate up and down, moving left to right, e.g., like a sinusoidal wave. The longitudinal axis 1108 corresponds to an x-axis, which represents distance the head portion 102 travels in the direction the lure 100 is being pulled (which is roughly the heading of the boat if the lure is being trolled or the direction the lure is being pulled by a fishing rod and reel if one is whipping). A y-axis represents distance orthogonal to the direction the lure 100 is being pulled, where positive and negative values represent, respectively, distances the head portion 102 moves above and below the longitudinal axis 108.

This two-dimensional movement of the head portion 102 can be mathematically represented by the simple harmonic wave function:

y(x, t)=A sin(kx+ω t+ϕ) (equation 1)

where x and y represent the distances mentioned above, t represents time, ω represents frequency, A represents the amplitude, and the mathematical term (kx+ω t+ϕ) represents the phase of the wave function.

Similarly, the two-dimensional movement of the tail portion 104 can be represented also by equation 1. The relative amplitudes and phases of the head portion and tail portion movements can be configured based on the curvature of the lure. For example, in one non-limiting embodiment, the relative oscillation phases of the head portion 102 and the tail portion 104 can be configured so that when the head portion 102 is at the top of its spiral, the tail portion 104 is at the bottom of its spiral. In other embodiments, the movements of the head portion 102 and the tail portion 104 can have some other relative phase so that, for example, when the head portion is at the top of its spiral, the tail portion is halfway between the bottom and the top of its spiral.

The curvature of the lure 100 generally determines any phase shifts between the movements of the head portion 102 and the tail portion 104. The corkscrew's shape appears like a sinusoidal wave and hence can also be mathematically represented by equation 1. Based on the curvature of the lure, the phase shift between the head portion 102 and tail portion 104 of the lure can, for example be set to 180 degrees, 90 degrees, 0 degrees (i.e., no phase shift and the head portion and tail portion spiral in phase around the longitudinal axis 108), or any other value.

The sharpness of the curve generally determines the distances at which the head portion 102 and the tail portion 104 each oscillates towards and away from the longitudinal axis 108 (which distances can mathematically be represented by the value A of equation 1). Depending on how the baitfish the lure 100 is designed to mimic swims (injured or otherwise), one may configure the head portion 102 and the tail portion 104 to oscillate at similar amplitudes or at different amplitudes. In the former case, similar amplitudes of oscillation refer, for example, to differences are not detectable by the naked eye (i.e., the distances at which each oscillate away from the lure's longitudinal axis 108 appears to the naked eye to be the same). In the latter case, the head portion 102 can oscillate at a greater amplitude than does the tail portion 104 or vice versa, and the extent of the difference again can be based on the manner in which the baitfish swims.

One reason for configuring the tail portion 104 to not oscillate too much is that the tail portion 104 is where a fishing hook is typically attached to the lure 100 (see FIG. 1), and having a hook that is whipping around too much as the lure 100 swims can reduce the probability of hooking the target fish securely. The extent to which tail portion 104 oscillates should mimic how the baitfish swims, but not exceed the capability of the target fish to strike the lure 100 and get securely hooked (usually determined by the size of its mouth, how quick its reflexes are, and how well it can see).

In one embodiment, movements of the head portion and tail portion are substantially 90 degrees out of phase and the amplitudes of their oscillations are different, with that of the tail portion 104 being greater than the head portion 102. This implementation produces a corkscrew action in which the tail appears to kick periodically, which can entice more strikes.

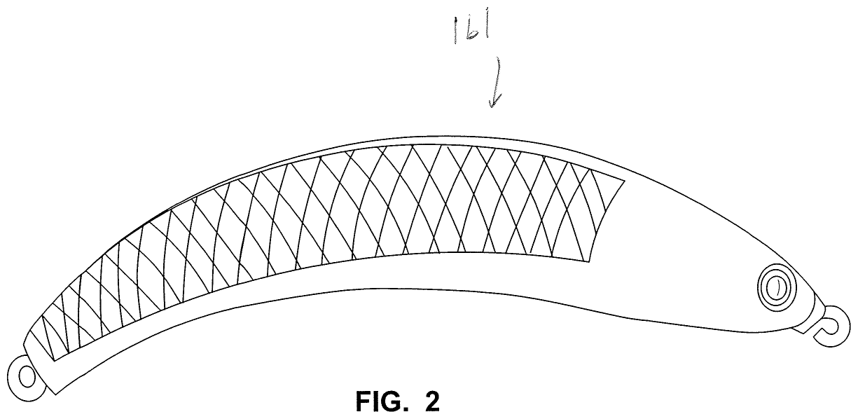

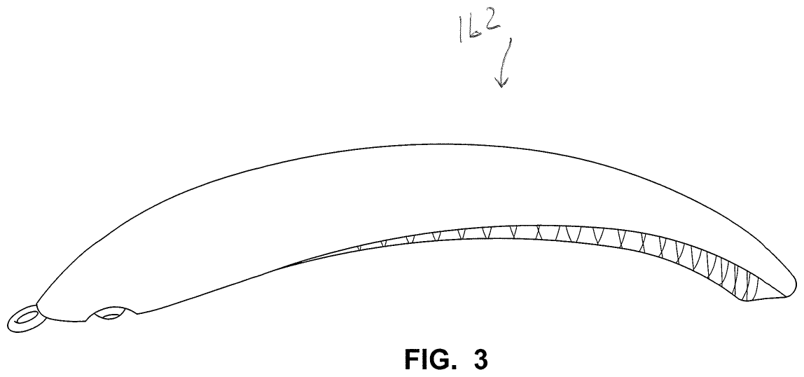

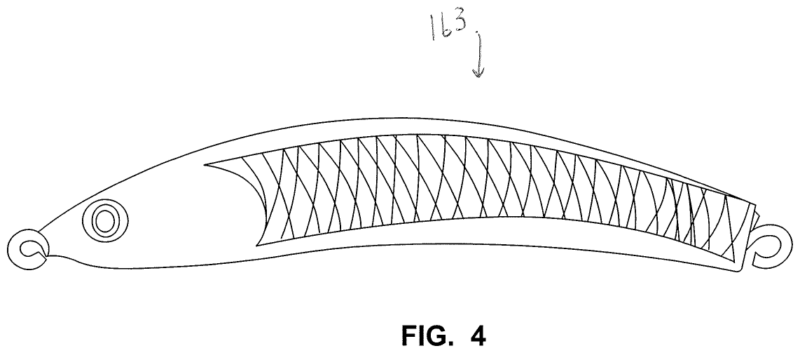

FIGS. 2-5 illustrates other example embodiments of lures 161, 162, 163, and 164. For example, the head portion and the tail portion of the lure 163 of FIG. 4 have less downward bend than the head portion and tail portion of the lure 161 of FIG. 2 for example.

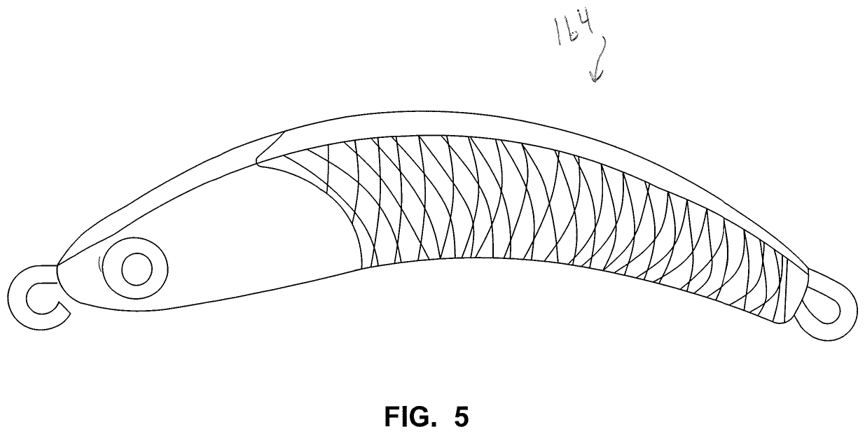

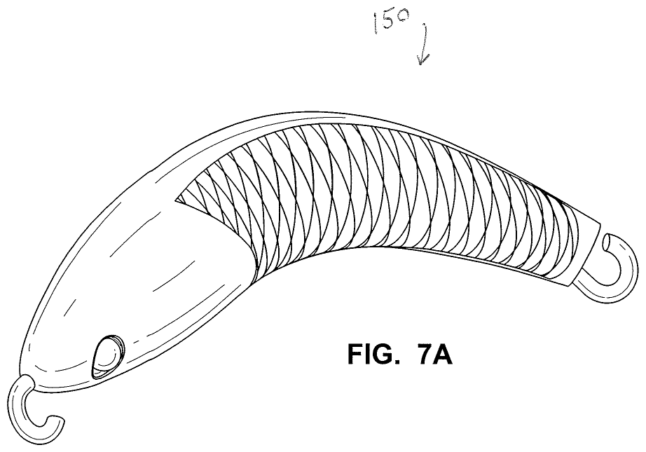

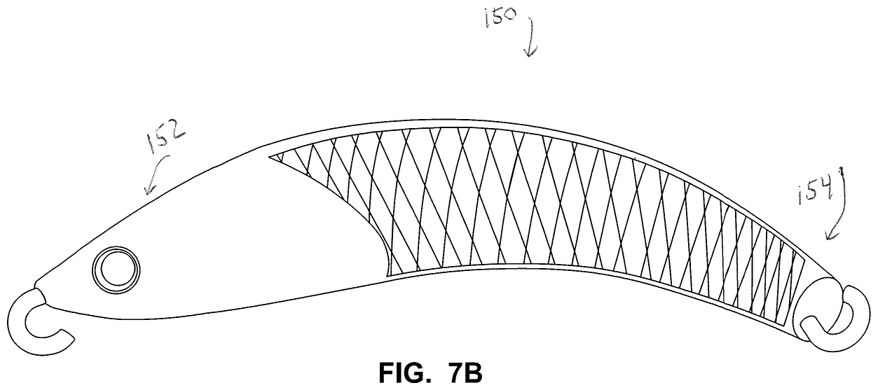

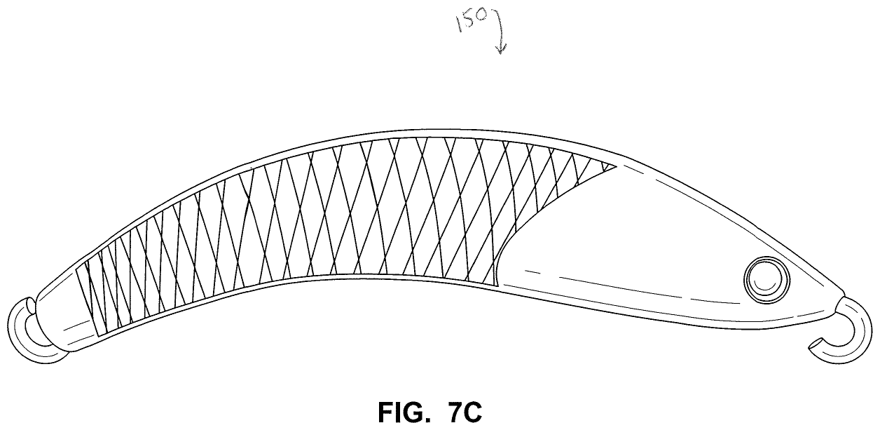

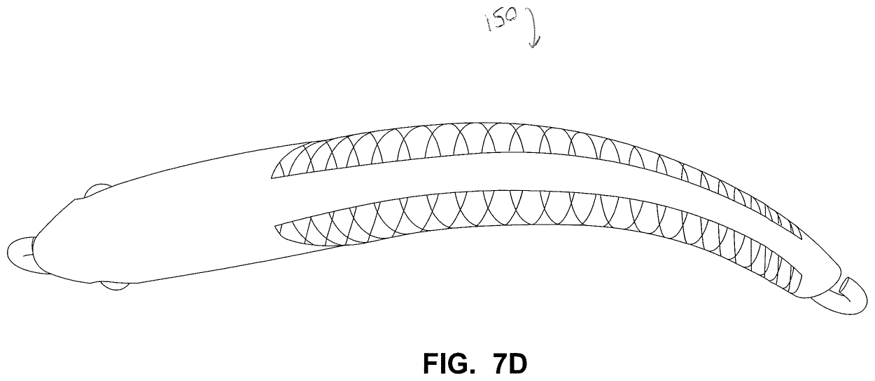

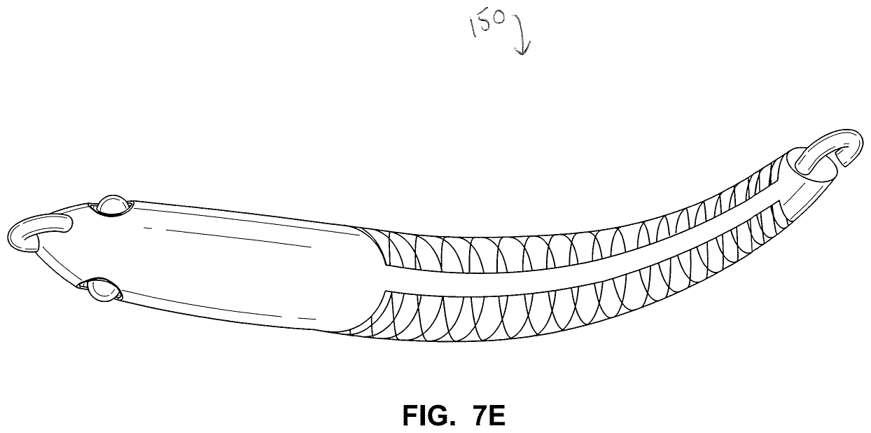

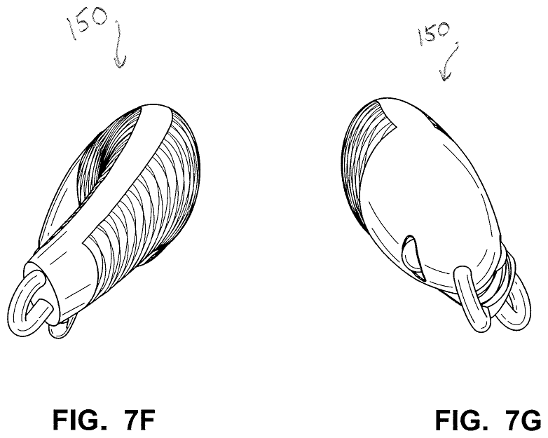

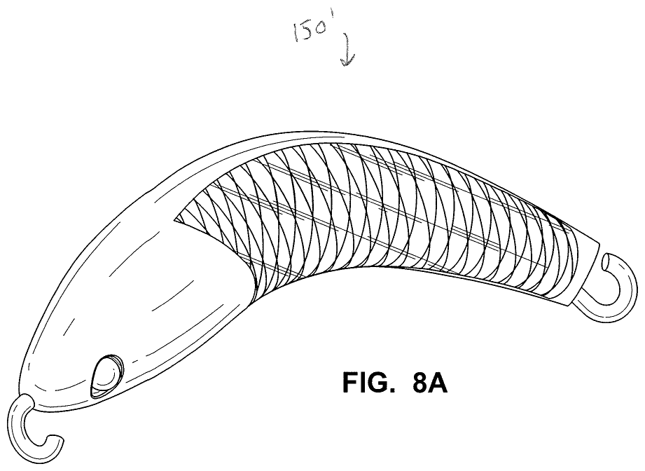

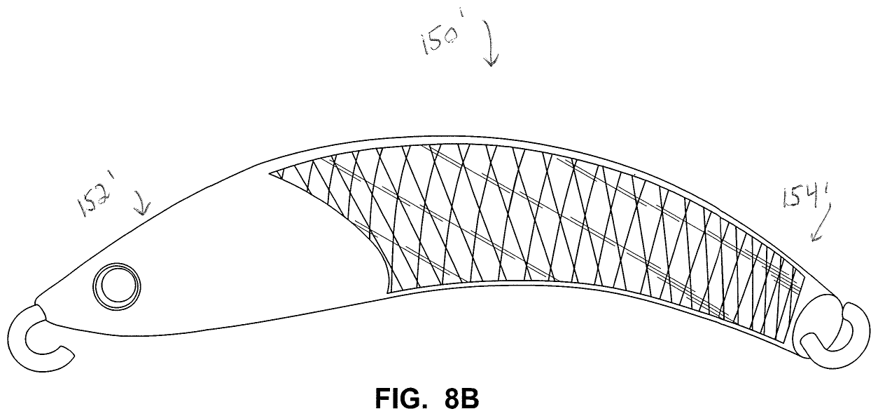

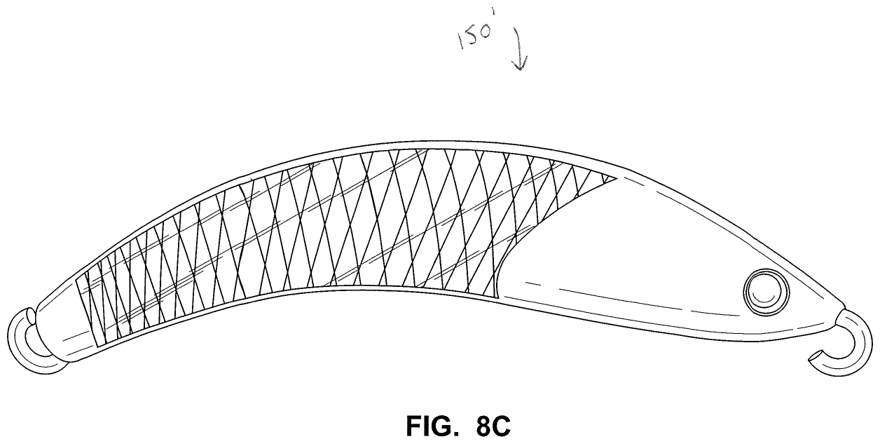

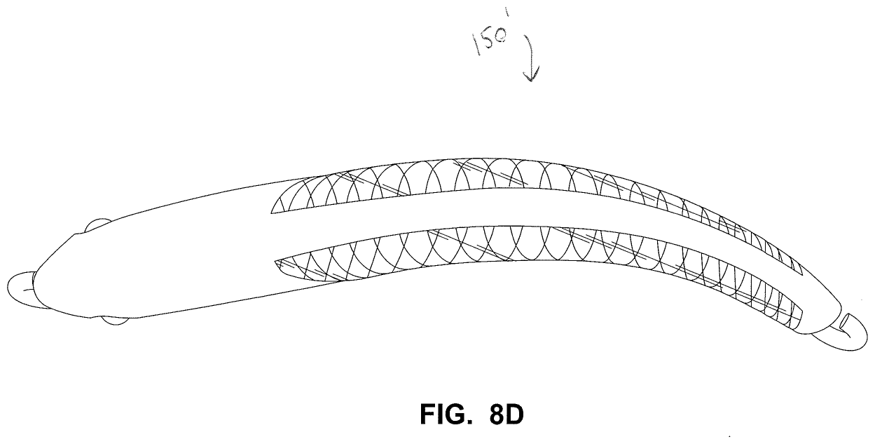

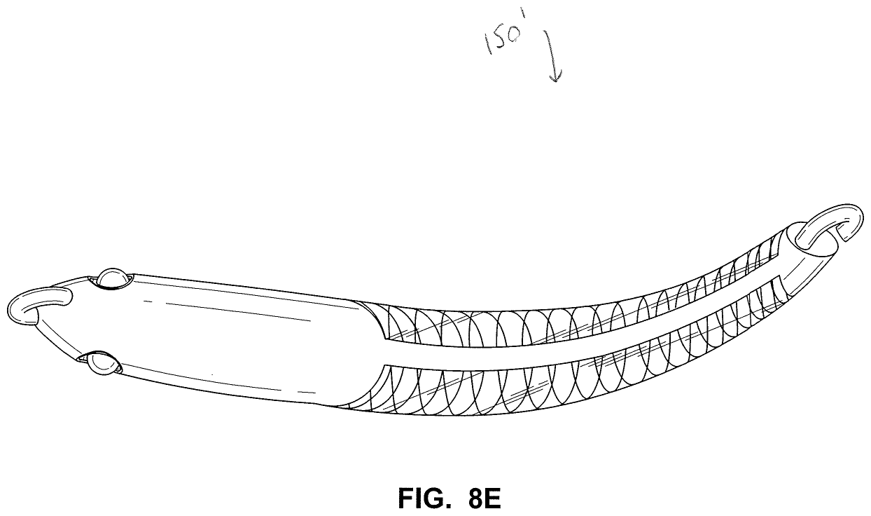

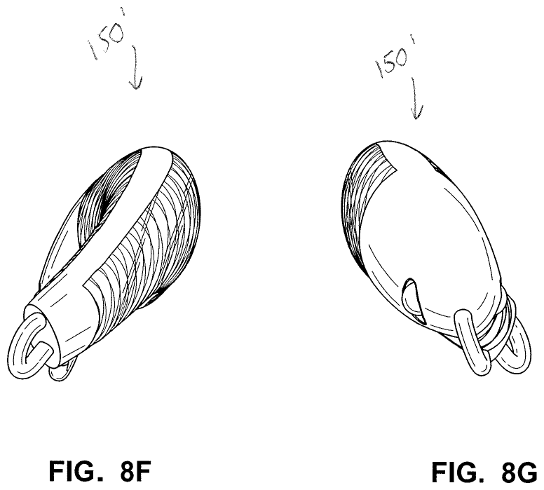

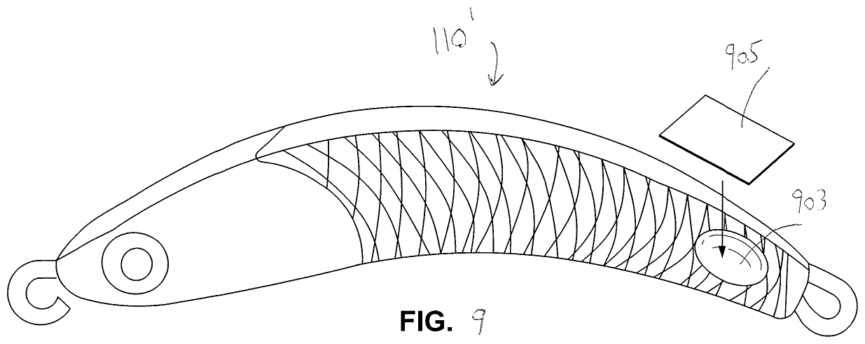

FIGS. 7A-7G and 8A-8G show respective front perspective views, front views, rear views, top views, bottom views, right side views, and left side views of example embodiments of a fishing lure 150 and a fishing lure 150′. The lures 150 and 150′ are shaped and curved to mimic the shape of a crippled anchovy and how it swims. The lure's head portions 152 and 152′ are bent down towards the longitudinal axes thereof, as are their tail portions 154 and 154′. Moreover, the tail portions are also bent sideways, as depicted in FIGS. 5D, 5F, 6D, and 6F, for example. Although these lures 150 and 150′ are shown with open loops provided at the head portion and the tail portion, it will be readily apparent that closed loops may also alternatively be used.

One technique for determining the curvature(s) of the lure 100 is by empirical experimentation in the field, preferably done under conditions that are the same as (or similar to) those for when and where the lure will be used to catch the target fish. For example, experimentation to make a lure for Northern CA king salmon should be performed on a particular fishing boat and at places where king salmon typically school and hunt before they run into San Francisco Bay, waters nearby Duxbury Reef and the Farallon Islands. Advantageously, experimentation can be timed to target a particular school of salmon, which tends to arrive in waves from spring to fall. Here, one can test various pinned, frozen anchovies of different shapes and curvatures that exhibit the various corkscrew actions described above.

The best shape and curvature determined in the manner can then be mold casted, which can preserve not only its shape and curvature, but also its texture, scales and all. There are various suitable casting techniques, examples of which include creating a two part mold using one-to-one silicone that is poured over the master lure. Once the mold is cured, the master is removed and in the void polyurethane casting resin is then poured into the mold, allowed to cure and then removed to create the lures. Alternatively, the best shape and curvature can be digitally scanned and then 3-D printed, which is convenient when the place where lures are fabricated and/or mass produced is located far from where field testing (and fishing) takes place. The material to make the lure can be resin, silicon, and/or rubber based, wood, or plastic, and hence can be rigid or soft once cured. In the case of the latter, the lure may include a suitably rigid spine in its body, either as part of the molding process or inserted afterwards, so that its corkscrew curve is preserved when pulled through water. Regardless of the options and alternatives, the result of this process is a lure that has a corkscrew action that mimics closely how a wounded or otherwise impaired anchovy swims.

As discussed above, the lure 100 may be trolled at different speeds, depending on the conditions under which it is being fished (e.g., weather, sea state, and boat speed). Field empirical experimentation hence can be done at different speeds to produce optionally a set of multiple lures, each having effective action for its respective trolling speed. Having such a set would be advantageous because a fisherman can simply swap to the appropriate lure to get the right lure action even when it is not convenient or possible to troll at a particular speed.

As shown in FIG. 1 and discussed above, an anchovy implementation of the lure 100 includes a closed loop 108, which is secured to its head portion 102. A fishing line can be tied to the ring or, if the loose end of the fishing line is attached to a snap swivel (not shown), the swivel can be detachably attached to the ring. The lure 100 includes a hook 112, which is attached to a swivel 114 and secured to the tail. Regardless of how the line and hook are secured to the lure, they must be able to withstand cyclic tension the lure must endure during its useful lifetime, which can include fighting salmon that on average weigh 20-30 lbs and that can weigh up to 85 lbs.

Optionally, the resulting lure is colored, e.g., by spray painting, to mimic the colors of the baitfish of baitfish, which for anchovies are various shades of silver and black. Alternatively, one can dye, foil, or brush paint the lure.

Optionally, the lure 100 is coated with a reflective coating to mimic the reflective slim and scales of anchovies. There are various ways to match the reflectance of anchovies, one of which is to field test various lures with varying reflectance (e.g., using slow motion video).

Optionally, with reference to FIG. 9, a lure 110′ may include a cavity 903 into which one can inject or insert scent that attracts the target fish. In one implementation, the cavity is a hole drilled into the lure after manufacture and covered with a porous tape 905. Alternatively, the cavity is created by including an object in the mold during the casting process so that the mold material cures around the object thereby forming the cavity.

A number of implementations have been described, but it should be understood that variations may be made. For example in one alternative implementation, the lure 100 has its head portion 102 and tail portion 104 attached so that one can adjust its curvature. Here, each of these portions can be made of a soft silicon based material and be attached to the rest of the lure 100 by a ratchable, and rotatable joint.

In another example embodiment, the lure can be configured so that fishing line passes through the lure, e.g., entering at the tip of the nose and exiting out the tail where there will be one or two hooks. This arrangement can be used with any of the lures described herein and is simply a different rigging option rather than having a hook affixed or screwed into lure. Such an arrangement may afford a degree of protection to the body of the lure from a hooked fish (e.g., from biting).

Besides anchovies, the teachings provided herein can be used to make lures to mimic other baitfish, salt or freshwater, e.g., herring, sardine, salmon, and trout smolts, or fry, and the disclosure is not limited in this respect.

In accordance with one aspect of the disclosure, a fishing lure includes a body shaped as a baitfish that has a head and a tail, wherein the body includes a head portion that mimics the head of the baitfish and a tail portion that mimics the tail of the baitfish, wherein the head portion is bent in a first direction and the tail portion is bent in a second, different direction so that the body is curved like a corkscrew arc; and wherein the head portion includes a tip, whereby when, towed through water by its tip, the lure corkscrews through water.

In accordance with an aspect of the disclosure, the lure corkscrews around a longitudinal axis; and the head portion spirals farther away from the longitudinal axis than does the tail portion.

In accordance with an aspect of the disclosure, the lure corkscrews around a longitudinal axis; and the tail portion spirals farther away from the longitudinal axis than does the head portion.

In accordance with an aspect of the disclosure, the lure corkscrews around a longitudinal axis; and the head portion and the tail portion spiral at similar distances away from the longitudinal axis.

In accordance with an aspect of the disclosure, the body of the lure has a reflective coating that reflects light to mimic the way the baitfish reflects light.

In accordance with an aspect of the disclosure, the body of the lure is colored to mimic colors of the baitfish.

In accordance with an aspect of the disclosure, the baitfish is one of an anchovy, a herring, a sardine, a freshwater minnow, a salmon smolt, trout smolt, or a fry.

In accordance with an aspect of the disclosure, the body of the lure comprises a material having a density to mimic the buoyancy of the baitfish.

In accordance with an aspect of the disclosure, a bending amount of the head portion and/or tail portion is adjustable; wherein the bending amounts of each of the head and tail portions determines an angular frequency at which the lure corkscrews when towed through water.

In accordance with an aspect of the disclosure, the head portion and tail portion of the lure are bent so that, when towed through water at a particular speed, the lure corkscrews at a particular angular frequency (e.g., by empirical determination) for attracting a fish species being targeted.

In accordance with an aspect of the disclosure, a swivel can be attached to the tip of the head portion, the swivel being configured to connect the lure to a fishing line and provide a freedom of movement that allows the lure to corkscrew when towed through water without over twisting the fishing line; and a hook connected to the tail portion in a manner so that the hook twirls along its shank and trails the lure when the lure is towed through water.

In accordance with an aspect of the disclosure, the hook is detachably connected with a swivel that provides a freedom of movement so that the hook can rotate at an angular frequency different that an angular frequency at which the lure corkscrews.

In accordance with an aspect of the disclosure, the lure defines a figurative cylinder when corkscrewing through water, and the hook trails the lure inside the figurative cylinder.

In accordance with an aspect of the disclosure, the body includes a porous area; and a cavity under the porous area, whereby scent that mimics the scent of the baitfish can be injected into the cavity and the scent trickles out through the porous surface when the lure is towed through water.

In accordance with an aspect of the disclosure, lure can be configured for passing line therethrough from the head portion to the tail portion.

In accordance with an aspect of the disclosure, a method for making a fishing lure comprises threading a bendable wire through an organic baitfish that has a head, a tail, a left side, a right side, and a belly; configuring the baitfish by empirically determining how much to bend the head of the threaded baitfish down towards its belly, how much to bend the tail of the baitfish down towards its belly and how much to bend its tail to either its left or right side, so that the baitfish corkscrews when towed through water and thereby looks like the baitfish is live and swimming injured; making a cast of the configured baitfish; filing the cast with a material that is rigid when cured, thereby forming a body of the lure, the body having the shape and curve of the configured baitfish, a head end that is shaped like the head of the baitfish, and a tail end that looks like the tail of the baitfish; and attaching a connector to the head end of the body, wherein the connector provides a freedom of movement so the lure can corkscrew through water.

In accordance with an aspect of the disclosure, the method of making the fishing lure further comprises painting the body to mimic the baitfish.

In accordance with an aspect of the disclosure, the method of making the fishing lure further comprises coating the body with a reflective coat to mimic the baitfish.

In accordance with an aspect of the disclosure, the method of making the fishing lure further comprises using, as the baitfish, an anchovy; a sardine; or a herring.

In accordance with an aspect of the disclosure, the method of making the fishing lure further comprises securing a hook to the tail end of the body with a swivel.

In accordance with an aspect of the disclosure, the method of making the fishing lure, wherein filling of the cast includes inserting an object the size of a scent chamber, wherein the object is removable when the fill material is cured to define a cavity; and securing porous tape over the cavity.

In accordance with an aspect of the disclosure, the method of making the fishing lure further comprises securing reflective tape to the body.

In accordance with an aspect of the disclosure, the method of making the fishing lure, the fill material is sandable when cured and the method further comprises sanding the body and towing the body through water to finetune the angular frequency at which it corkscrews.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1: A fishing lure, comprising:
a body shaped as a baitfish that has a head and a tail, wherein the body includes:
a head portion that mimics the head of the baitfish and a tail portion that mimics the tail of the baitfish, wherein the head portion is bent in a first direction and the tail portion is bent in a second, different direction so that the body is curved like a corkscrew arc,
wherein the head portion includes a tip, whereby when towed through water by its tip, the lure corkscrews through water.

2: The lure of claim 1, wherein:
the lure corkscrews around a longitudinal axis; and
the head portion spirals farther away from the longitudinal axis than does the tail portion.

3: The lure of claim 1, wherein:
the lure corkscrews around a longitudinal axis; and
the tail portion spirals farther away from the longitudinal axis than does the head portion.

4: The lure of claim 1, wherein:
the lure corkscrews around a longitudinal axis; and
the head portion and the tail portion spiral at similar distances away from the longitudinal axis.

5: The lure of claim 1, wherein:
the body has a reflective coating that reflects light to mimic the way the baitfish reflects light.

6: The lure of claim 2, wherein:
the body is colored to mimic colors of the baitfish.

7: The lure of claim 3, wherein:
the baitfish is one of: an anchovy, a herring, a sardine, a freshwater minnow, a salmon smolt, trout smolt, or a fry.

8: The lure of claim 1, wherein:
the body comprises a material having a density to mimic the buoyancy of the baitfish.

9: The lure of claim 1, wherein:
at least one of the head portion is configured for adjustment by bending; and
the tail portion is configured bent is adjustable, and wherein how much each of the head and tail portions are bent dictates an angular frequency at which the lure corkscrews when towed through water.

10: The lure of claim 9, wherein:
the head portion and tail portion are bent so that, when towed through water at a particular speed, the lure corkscrews at a particular angular frequency empirically determined to attract a fish species being targeted.

11: The fishing lure of claim 1, further comprising:
a swivel attached to the tip of the head portion, the swivel being configured to connect the lure to a fishing line and provide a freedom of movement that allows the lure to corkscrew when towed through water without over twisting the fishing line; and
a hook connected to the tail portion in a manner so that the hook twirls along its shank and trails the lure when the lure is towed through water.

12: The lure of claim 11, wherein:
the hook is detachably connected with a swivel that provides a freedom of movement so that the hook can rotate at an angular frequency different that an angular frequency at which the lure corkscrews.

13: The fishing lure of claim 12, wherein:
the lure defines a figurative cylinder when corkscrewing through water, and the hook trails the lure inside the figurative cylinder.

14: The lure of claim 1, wherein:
the body includes a porous surface; and
a cavity under the porous area, whereby scent that mimics the scent of the baitfish can be injected into the chamber and the scent trickles out through the porous surface when the lure is towed through water.

15: The lure of claim 1, configured for passing line therethrough from the head portion to the tail portion.

16: A method for making a fishing lure, the method comprising:
threading a bendable wire through an organic baitfish that has a head, a tail, a left side, a right side, and a belly;
configuring the baitfish by empirically determining how much to bend the head of the threaded baitfish down towards its belly and how much to bend the tail of the baitfish down towards its belly and how much to bend its tail to either its left or right side, so that the lure corkscrews when towed through water and thereby looks like the baitfish is live and swimming injured;
making a cast of the configured baitfish;
filing the cast with a material that is rigid when cured, thereby forming a body of the lure, the body having the shape and curve of the configured baitfish, a head end that is shaped like the head of the baitfish, and a tail end that looks like the tail of the baitfish; and
attaching a connector to the head end of the body, wherein the connector provides a freedom of movement so the lure can corkscrew through water.

17: The method of claim 16, further comprising:
painting the body to mimic the baitfish.

18: The method of claim 17, further comprising:
coating the body with a reflective coat to mimic the baitfish.

19: The method of claim 18, wherein the baitfish is one of an anchovy;
a sardine; or a herring.

20: The method of claim 16, further comprising:
securing a hook to the tail end of the body with a swivel.

21: The method of claim 20, further comprising:
filling the cast includes inserting an object the size of a scent chamber, wherein the object is removable when the fill material is cured to define a cavity; and
securing porous tape over the cavity.

22: The method of claim 16, further comprising:
securing reflective tape to the body.

23: The method of claim 16, wherein the fill material is sandable when cured and the method further comprises:
sanding the body and towing the body through water to fine-tune the angular frequency at which it corkscrews.
